(19) United States
(12) Patent Application Publication
(10) Pub. No.: US 2007/0168926 A1
(43) Pub. Date: Jul. 19, 2007

(54) Software customization framework

(76) Inventors: Raghuram Rajah, Cumming, GA (US); Imad Mouline, Braintree, MA (US); Jeffrey Schilling, Charlotte, NC (US); Barbara McInnes, Dublin (IE); Rodney Birch, Dublin (IE)

Correspondence Address: SMITH FROHWEIN TEMPEL GREENLEE BLAHA, LLC, Two Ravinia Drive, Suite 700, ATLANTA, GA, 30346, US

(21) Appl. No.: 11/303,753

(22) Filed: Dec. 16, 2005

(51) Int. Cl. G06F 9/44

(52) U.S. Cl. 717/104; 717/106

(57) ABSTRACT

A software customization framework based upon an enterprise platform comprises a metadata framework, a service layer, and an object layer. The metadata framework comprises a generic domain class. The generic domain class defines one or more extension classes. The service layer receives one or more requests from a client and processes the requests via a dispatch service which forwards a call to a generic executable object. The object layer generates the generic executable object at run time. The generic executable object uses the extension class to identify data, an operation, and a select dispatch scheme. The generic executable object also invokes a handler responsive to the call. The handler uses the select dispatch scheme to implement a desired operation in the data structure responsive to the data and the operation from the executable object.

Modern enterprise software is designed to meet the needs of potential customers by analyzing the requirements of a broad set of customers. These requirements become inputs to the software development process where a version of software that meets those requirements is generated. As new or changing requirements are captured from potential or existing clients, a new version of the software is generated with interfaces and functionality targeted to meet the new requirements.

While this procedure works adequately for limited, relatively static domains and customer profiles, it is problematic for other domains and customer profiles. Customers often have a complex mixture of specific-requirements that general requirements often cannot capture. In addition, requirements may not be consistent across various customer sites. In some situations, requirements may change faster than the software development team can design code to address the changes. In other situations, customer requirements may be so specific that it is not cost effective for the enterprise software developer to write code to address each requirement.

Enterprise software development problems are generally more complex due to broader automation requirements, constantly changing user profiles, and increased business practice diversity. Additionally, there are significant market pressures to reduce costs and accelerate delivery schedules for adapting enterprise software to meet specific, as opposed to general business requirements.

Previous generations of enterprise software were expected to automate a single static business process. Today, enterprise software is expected to automate multiple, dynamic business processes. In addition, enterprise software is expected to provide seamless inter-operability and information access across these multiple processes.

The users of enterprise applications have also changed. Previously, enterprise software was expected to maximize the productivity of inexpensive unskilled information-workers. Now the expectation is to maximize the productivity of relatively expensive and skilled knowledge-workers. Consequently, enterprise software is expected to deliver complicated, general, and unstructured information access and analysis.

The above-mentioned forces and circumstances have a profound effect on enterprise software. Current development methods are not well equipped to deal with the issues that result. This shortcoming has been understood for a while within the software development industry. As a result, some end users have chosen to develop their own software in-house because past software vendors have been unable to demonstrate a product that addresses their needs.

Other end users continue to work with enterprise software developers. Many of these enterprise software providers apply one or both static-code customization and dynamic configuration. Static-code customization is provided in software packages coupled with a development environment that can be used by software developers to modify compiled code to match their requirements. This strategy includes the component style architectures built on standard object models such as object linking and embedding (OLE), Java beans, etc. This approach has several drawbacks. The customer must either have in-house development expertise or hire hard to find and expensive consultants. This development approach is slow and expensive and has to be repeated as requirements change. In addition, when the vendor supplies upgrades to software, the customer's customizations often have to be performed over again or modified to ensure nominal operation with the new version of the software.

Dynamic configuration is provided by software packages that include a broad and/or deep set of run-time options that can be set by the customer to dynamically configure the software to meet customer specific requirements. This approach also has its drawbacks. Current software development environments do not adequately support the complex modeling problem presented by this high degree of run-time configurability because the software-models they are based on do not provide adequate solutions to the problems faced by a modem enterprise software system. Software models fall short in important features of modularity, abstraction, and configurability that are vital to application developers. This makes sense in that the traditional history of software environments is that they are first designed to meet the requirements of low-level system implementers with the needs of application level developers left as an afterthought. For example, both Java and C++ were first designed to solve system level problems. Software environments are typically implemented by people with low-level system expertise, and they naturally craft solutions for the problems that they face and understand.

In many ways, the entities that system designers model and the entities that application designers model are inherently different. System entities are short-lifetime, static and single-dimension. Application entities are long-lived, dynamic and multi-dimensional. System software deals with entities that have a lifetime that is linked to the process in which they are running. For instance, a memory-buffer is gone from the system's memory the second the process is stopped. In contrast, an application entity typically has a lifetime that is linked to real world external entities. Thus, the application entity generally has a lifetime at least as long as the real-world entities. An employee entity needs to be continuously managed even if the system that created it is modified. This aspect of persistence at the application level software leads to many new and different challenges as compared to system level software.

Another difference between system and application software is that application software faces run-time evolution. This is the natural and inescapable fact that real world persistent entities change their roles over time. An employee may be a contractor one day, and a full-time employee the next. A company may be bought by another and face different policies. System software typically has no concept of run-time evolution because the entities that they represent do not change significantly in their lifetimes. In contrast, application software has to deal with this problem constantly.

Still another difference between system and application software is that application software faces much more difficult design-time evolution. This is the also inescapable fact that software applications change over time, and the entities they create along the way are a persistent legacy for each new version of the software to manage. The software system design needs to be able to change, but still contain the same entities. System software can generally store its internal memory buffers in any form it chooses as long it implements the same protocol or application programmer's interface (API).

Unlike system software, application software has much more complicated multi-dimensional entities. The requirements of an employee type with all of the variations that customers require to meet their policies, and all of the contexts in which they are used, is substantively different from the system memory-buffer. A normal application entity is used in many processes, perhaps in different regions, states, or even countries, with different user-interface styles, by people of different expertise, and in many different business environments.

Current software models have a substantial list of shortcomings in more than a few areas. The discussion of these shortcomings will focus on object-models because they are the current state of the art.

One of the challenges that an object system designer faces is that they want to modify the objects they have designed to achieve new objects that are different from the previous objects, but still act like the previous objects under certain conditions. Object system designers generally also want to be able to re-use the code they wrote for these objects. This is commonly done by using inheritance hierarchies; but there is a large drawback to this technique: inheritance is static by nature. Once an object is created, it is restricted to one definition for its lifetime. This is not a problem for system software, but presents a substantial problem for application software. There are other techniques that can be used with object models such as delegation or parameterization; but since the object models do not support these techniques directly, they leave the software designer to provide these features for themselves. This demands unnecessary complex code with all of the inherent time and expense.

Therefore, it would be desirable to provide an improved object specialization technique.

### SUMMARY

Embodiments of a software customization framework are responsive to a generic domain class in a metadata framework. The software customization framework comprises an enterprise platform coupled to a data structure. The enterprise platform comprises a metadata framework, a service layer and an object layer. The metadata framework is configured with the generic domain class and one or more extension classes. The service layer receives one or more inputs from a client interface and includes a dispatch service which forwards a call to a generic executable object. The object layer generates the object at run time and invokes a handler responsive to the call. The generic executable object uses an extension class to emulate a desired object behavior and invokes a select dispatch scheme for a handler defined in an extensible markup language. The handler implements an operation responsive to the generic executable object within the data structure.

One embodiment of a method for extending core application behavior of an enterprise platform without generating code every time a new domain class is added to metadata comprises adding information to metadata defining a generic domain class, using the generic domain class to define an extension class including fields, an operation, and a dispatch scheme, integrating the metadata with an enterprise platform, generating a generic domain object, defining a mechanism for invoking a dispatch service that generates an executable object at run time responsive to the extension class and implementing a handler responsive to the dispatch scheme to manipulate data in a data structure.

An alternative embodiment of a method for extending core application behavior of an enterprise platform comprises providing a base set of tables and classes configured to implement a core set of functions, defining an extension class in accordance with a generic domain class in metadata, defining a generic domain object, and providing a dispatch service configured to receive a request to perform an operation via the generic domain object, use the extension class and the generic domain object to emulate an executable object responsive to the request, and directing a multiple dispatch scheme directed handler defined via a generic handler attribute in the metadata to implement the operation on data in a data structure.

### BRIEF DESCRIPTION OF THE FIGURES

The systems and methods for extending an application using a software customization framework can be better understood with reference to the following figures. The components within the figures are not necessarily to scale, emphasis instead being placed upon clearly illustrating the principles behind the systems and methods. Moreover, in the figures, like reference numerals designate corresponding parts throughout the different views.

FIG. 1 is a schematic diagram illustrating an embodiment of a business architecture.

FIG. 2 is a schematic diagram illustrating an alternative embodiment of the business architecture of FIG. 1.

FIG. 3 is a schematic diagram illustrating an embodiment of a software customization framework that can be integrated with the enterprise platform of FIGS. 1 and 2.

FIG. 4 is a flow diagram illustrating an embodiment of a method for extending core application behavior of an enterprise platform that can be implemented by the software customization framework of FIG. 3.

FIG. 5 is a flow diagram illustrating an embodiment of an alternative method for extending core application behavior of an enterprise platform that can be implemented by the software customization framework of FIG. 3.

FIG. 6 is a schematic diagram illustrating the operation of alternative handlers.

FIG. 7 is a schematic diagram illustrating information flow across the software customization framework of FIG. 3.

### DETAILED DESCRIPTION

Customizations to an application model within an enterprise system are made possible using a software customization framework. The described systems and methods produce a software customization framework that can be used to create and manipulate custom objects at run time without having to generate code. That is, without having to write concrete services, objects, or value object classes. A user of the software customization framework defines a new domain class in metadata as a generic domain class. Requests are forwarded to a dispatch service, which dynamically generates a corresponding object and calls a handler to implement a requested operation on the class. The software customization framework eliminates the need to generate custom code and value object code each time a new domain class is added to metadata. Once the user has defined metadata for the class and implemented a handler, calls can be made via the dispatch service to the newly created custom object.

To create and manipulate instances of a custom object, client applications send requests to and invoke operations on the object by means of a dispatch service. Each client sends requests based on generic value objects for a previously generated generic domain class defined in metadata on an enterprise platform. The generic value objects, together with operations defined in the metadata are passed to the dispatch service. The dispatch service forwards a call to a corresponding object, which passes the call to a handler, which in turn provides the implementation for the desired operation(s).

The software customization framework supports enterprise platform modifications that do not require the extension of an application's object model and behavior. That is, the software customization framework is appropriate when no new Java classes will be implemented with the data model. The software customization framework also supports enterprise platform modifications with minimum performance requirements. The software customization framework provides flexibility in lieu of performance as the software customization framework is executed during run time in response to client application requests.

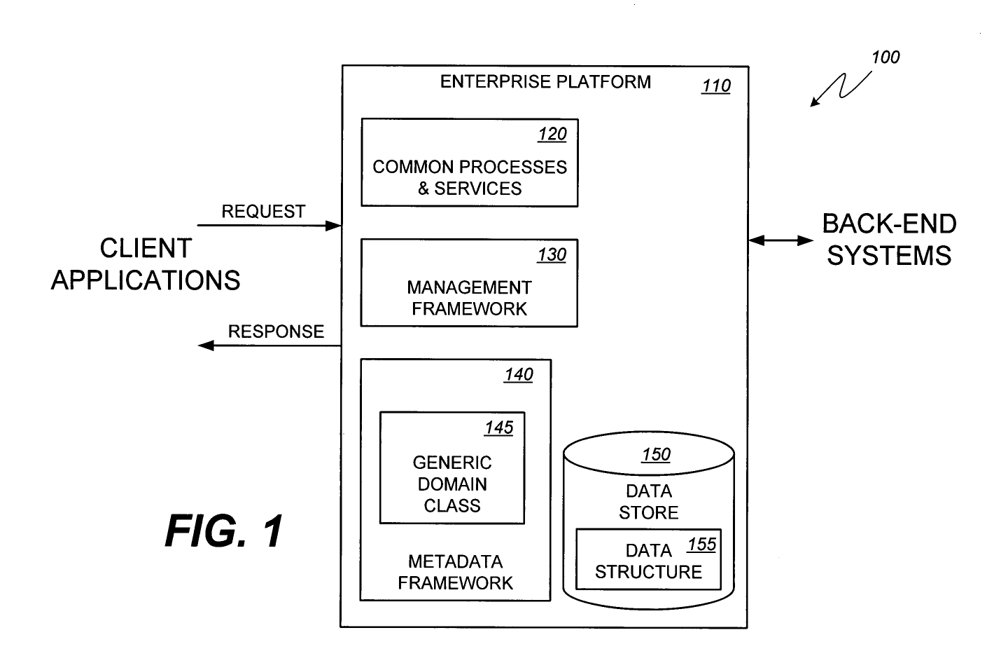

There are a host of business cases where it is appropriate to use the software customization framework to extend or otherwise modify client applications. The illustrated embodiments present two scenarios by way of example. A first scenario describes creating and suspending a custom account. A second more complex scenario describes the integration of an enterprise platform application with non-enterprise applications, such as an Internet service or an application-to-host system. For example, a bank may have an Internet service that performs credit checks for users of their system and the bank may desire to integrate this function into the enterprise platform. Having described the general operation of the software customization framework, various additional embodiments will be described with respect to FIGS. 1-7 below.

FIG. 1 is a schematic diagram illustrating an embodiment of an enterprise system architecture 100. As shown in FIG. 1, an enterprise platform 110 is provided between client applications and back-end systems to service one or more requests forwarded to the enterprise platform 110 from one or more client applications. Client applications comprise any combination of hardware, software and firmware configured to communicate with enterprise platform 110. Client applications will comprise a source program, executable program (object code), script, or any other entity comprising a set of instructions to be performed. Client application communications include requests for information and/or information translations or other data operations that are served by enterprise platform 110. In some situations enterprise platform 110 is appropriately configured to respond to the client application request. When this is the case, back-end systems are bypassed. In other situations, enterprise platform 110 will not contain the necessary data and/or executable instructions to satisfactorily address the client application request. When this is the case, enterprise platform 110 is configured to forward the request or information derived from the request to back-end systems.

In one embodiment, enterprise platform 110 is built on a commercial off-the-shelf (COTS) Java 2 enterprise edition (J2EE) application server. Enterprise platform 110 comprises common processes and services 120, management framework 130, metadata framework 140, and data store 150. Enterprise platform 110 uses a set of common processes and services 120 and a management framework 130 to implement a host of data interactions and manipulations between both external and internal entities. Common processes and services 120 include a host of programs dedicated to performing a task and managing platform resources. Common services and processes 120 may be implemented using various technologies, including but not limited to, XML, SOAP, WSDL, UDDI, etc. Management framework 130 includes a plurality of rules and operational parameters for supporting runtime core functionality. Management framework 130 directs file and network operations, provides access to platform services, manages access and interaction with data store 150 including interaction with data structure 155 and similar access and interaction with back-end system data stores, and provides support for constructing client applications.

Metadata framework 140 comprises information that describes data stored, manipulated, or otherwise processed within enterprise platform 110. Metadata framework 140 includes information that describes how, when, and by whom a particular set of data was collected, how the data is arranged, and in some cases who is authorized access and/or manipulate the underlying data. As illustrated in FIG. 1, metadata framework 140 includes generic domain class 145. Generic domain class 145 defines a construct for identifying an object at runtime. Generic domain class 145 is identified by a name and includes one or more fields, one or more operations, and is associated with a dispatch scheme, i.e., the generic domain class 145 identifies a particular handler for implementing the one or more operations. The dispatch scheme determines what kind of handler is used and a respective loader associated with that scheme loads the actual handler implementation.

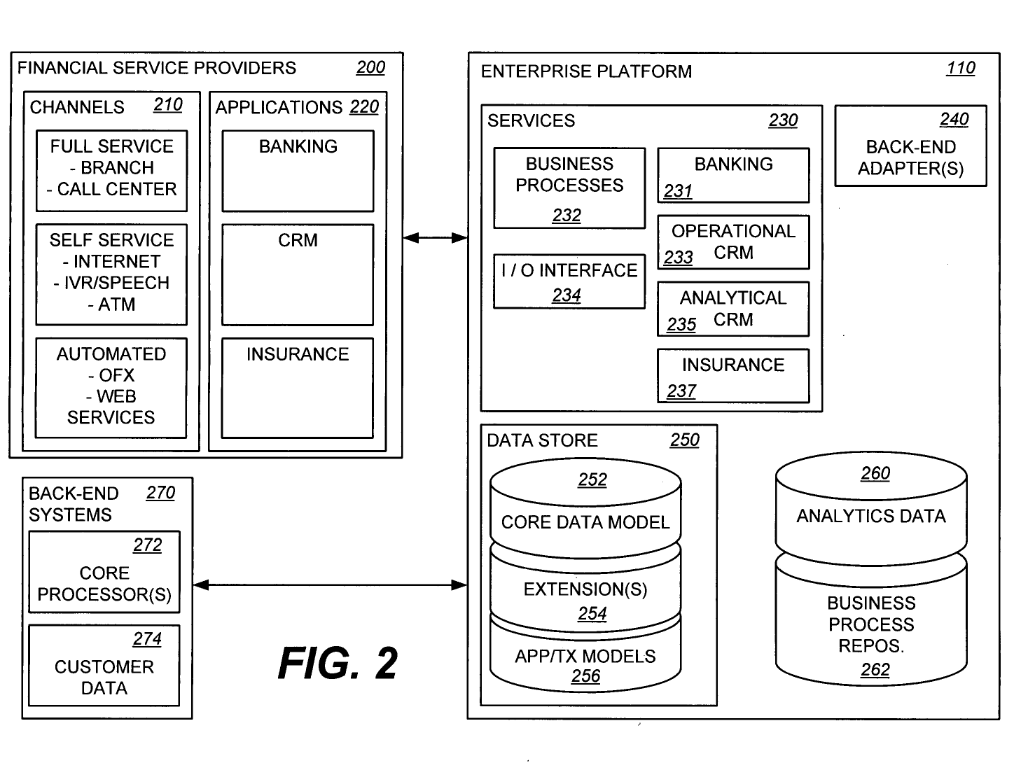

FIG. 2 is a schematic diagram illustrating an alternative embodiment of the enterprise system architecture 100 of FIG. 1. In this embodiment, the enterprise platform 110 functions as a front-office to financial service providers 200. Enterprise platform 110 is configured in accordance with a service-oriented architecture with enterprise services 230 configured to use a set of underlying building blocks, components, etc., called processes when appropriate. These enterprise services 230 are components that are put together in a flexible manner to deliver the desired business logic. As an added form of flexibility, the business logic can be exposed as a set of easily adaptable business processes 232, which, when paired with the appropriate user interfaces, such as I/O interface 234, enable a specialized application, such as banking 231, operational customer relationship management 233, analytical customer relationship management 235, and insurance 237, among other (not shown) to interface with financial service providers 200. The various enterprise services 230 are typically accessed via one or more channels 210 to assist financial service provider applications 220.

Applications 220 may include any suitable banking, customer relationship management (CRM), insurance applications, among other applications (not shown). Applications 220 comprise groupings of specific features, functions, business processes, etc. Enterprise platform 110 includes corresponding services/processes for supporting each type of application (e.g., banking services 231, business processes 232, operational CRM 233, analytical CRM 235, and insurance services 237.

Channels 210 represent the many interfaces between the financial service providers 200 and their customers. Channels 210 include full-service branch and call-center channels, self-service channels, such as Internet, automatic-voice recognition, and automated-teller machines (ATMs), and automated channels, such as open-financial exchange (OFX) and Web services. For example, channels 210 may require specific presentation logic in order to implement applications 220. Financial service providers 200 may include full-service channels (e.g., branch, call center, etc.) for human-to-human interactions, self-service channels (e.g., Internet, integrated voice response (IVR), ATM, etc.) for human-to-machine interaction, and automated channels (e.g., an OFX, interactive financial exchange (IFX), web services, etc.) for machine-to-machine interaction.

The overall service-oriented architecture promotes reuse within applications 220 as is appropriate. Because services 230 are accessible via industry-standard web services interfaces, these building blocks can be reused by the financial service provider applications 220 to form a more seamless solution to financial service providers 200.

Enterprise platform 110 includes a data store 250 for storing core data model 252, extensions 254, and application/transaction data model(s) 256. Core data model 252 comprises a customer-centric, application-neutral data model. Applications 220 (and other third parties) may extend core data model 252 to specialize their data and their behaviors via extensions 254. Application/transaction data model(s) 256 may be owned by specific applications 220 and may not be published or meant to be extended, except through an application software development kit (SDK).

Enterprise platform 110 also includes analytics data store 260 and business process repository 262. Analytics data store 260 comprises a component used for analytical processing on data sourced from a variety of systems. Business process repository 262 stores definitions of application-specific and/or common processes as desired.

Enterprise platform 110 may includes various adapters (e.g., backend adapters 240) for providing front-office access to backend systems 270 containing core processors 272 and customer data 274. Backend systems 270 may comprise any host system or other system of record. Backend adapters 240 may operate in four different modes: real-time; real-time with batch back-up; hybrid; and batch. In real-time mode, applications and services go immediately to backend systems 270. No data is stored locally and services are only available if an identified backend system is available. In real-time/batch back-up mode, applications and services go immediately to backend systems 270. Data is stored locally as a back-up, but used only if an identified backend system 270 becomes unavailable. In hybrid mode, access to a specific backend system 270 is configured so that some transactions are accessed in real-time, whereas others are accessed in batch mode. In batch mode, no real-time access to backend systems 270 is available. The local database acts as a stand-in for the backend system 270 and appropriate synchronization occurs.

One of ordinary skill in the art will appreciate that enterprise platform 110 may be designed using a set of common services and frameworks. In one embodiment, enterprise platform 110 is built on a COTS J2EE application server. It should be further appreciated that services 230 may be implemented using various technologies, including but not limited to, XML, SOAP, WSDL, UDDI, etc. It should be further appreciated, however, that alternative embodiments may include other technologies.

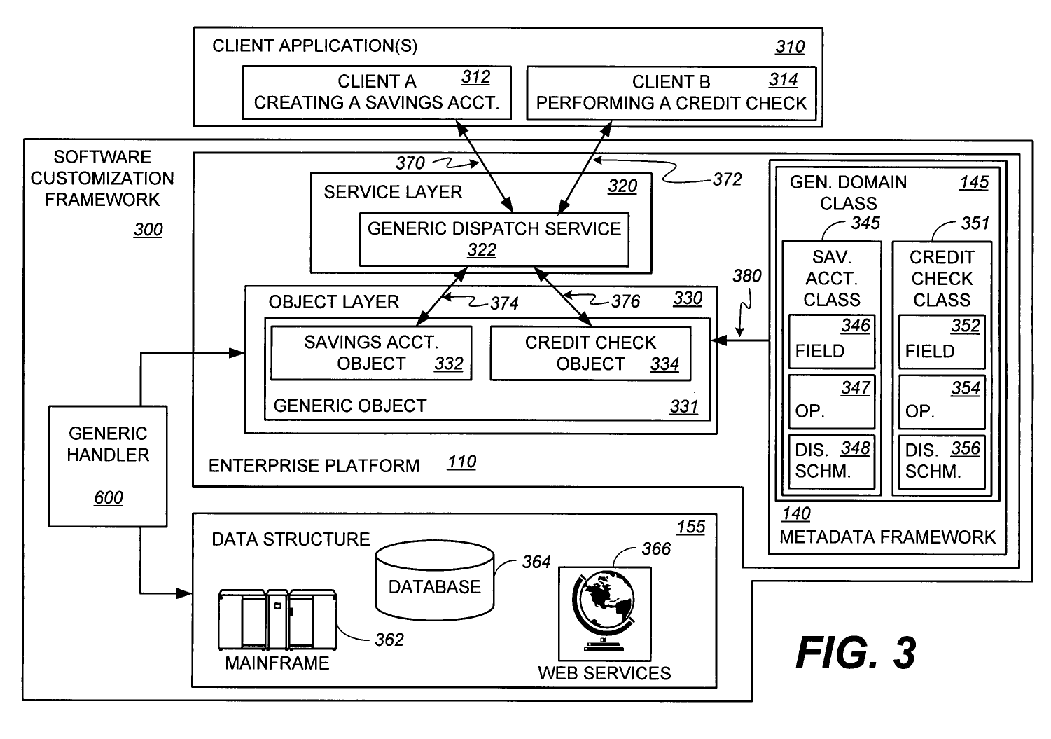

FIG. 3 is a schematic diagram illustrating an embodiment of a software customization framework 300 that can be integrated with the enterprise platform 110 of FIGS. 1 and 2. As illustrated in FIG. 3, software customization framework 300 includes enterprise platform 110 and data structure 155. Enterprise platform 110 includes service layer 320, object layer 330, and a metadata framework 140 configured to identify various schemes for storing, modifying and accessing data consistent with data structure 155.

Service layer 320 includes generic dispatch service 322, which acts as a gateway between client applications 310 and one or more business objects. As indicated in FIG. 3, generic dispatch service 322 receives requests from client applications 310 and invokes operation(s) 354 that are defined in a generic domain class 350 in the metadata framework 140. Request 370 is forwarded on behalf of client A via application 312 to generic dispatch service 322. Request 372 is forwarded on behalf of client B via application 314 to generic dispatch service 322. Any application that needs to store information to a data base 364 or mainframe 362 and or forwards data via web services 366 uses an object to accomplish the operation. Generic dispatch service 322 communicates with various objects via invoke operations. Invoke operation 374 is forwarded on behalf of client A to savings account object 332. Invoke operation 376 is forwarded on behalf of client B to credit check object 334. The metadata framework 140 includes data about the object(s). The metadata framework 140 includes information regarding fields and operations contained within the object(s), the data base table that will be operated on, etc. For example, savings account class 345 within the metadata framework 140 comprises at least one field 346, at least one operation 347 and a dispatch scheme identifier 348. Similarly, credit check class 351 comprises at least one field 352, at least one operation 354, and a dispatch scheme identifier 356. Users of the software customization framework 300 can add and/or modify new objects by writing metadata and providing an appropriate dispatch scheme.

In the example embodiment, software customization framework 300 supports custom objects, such as savings account object 332 and credit check object 334 defined as generic domain classes savings account class 345 and credit check class 351 in the metadata framework 140. The generic dispatch service 322 forwards each request or call to the identified object of the domain class, which in turn forwards the call to an identified handler (not shown) to complete one or more identified operations. To invoke operations, the generic dispatch service 322 uses the following methods. An invokeFactory( ) function, invokes the factory methods defined in a generic object. Factory methods on a domain class are operations that return an instance or a collection of instances of that domain class. These factory methods may use a query to fetch the result set. An invoke( ) function, invokes operations defined on the generic object. The generic dispatch service 322 delegates the call to the generic object, which invokes the handler defined via a generic handler attribute in the metadata. Handlers are a workflow, a plain old Java object or a mediator implemented in Java.

Each of the objects, that is, savings account object 332 and credit check object 334, are defined by an object model. The object model consists of a value object and a generic object. The value object serves as the interface between the client application 310 and the generic dispatch service 322. The client application 310 provides a value object that represents a class. The value object, along with required operations, is passed via a request to the generic dispatch service 322, which generates an object. A getDomainClassName function returns the domain class name for the value object. This allows the metadata framework 140 to return information based on the actual domain class name being created. The generic object provides an interface for the generic domain class. The generic object wraps a value object and invokes the requested operations on the generic handler that is configured for the associated domain class operation. Interface 380 communicates metadata from metadata framework 140 to generic object 331. Thereafter, the generic handler class implements the requested operation.

The generic object contains the following methods. A getDomainClassName( ) method returns the domain class name for the object being created (e.g., savings account). An invoke( ) method invokes the identified operation. The operation can be an implicit operation (e.g., create, read, update, delete) or the operation can be explicitly defined in metadata for the domain class. Operations on data within data structure 155 are completed by generic handler 600 as directed by an identified dispatch scheme.

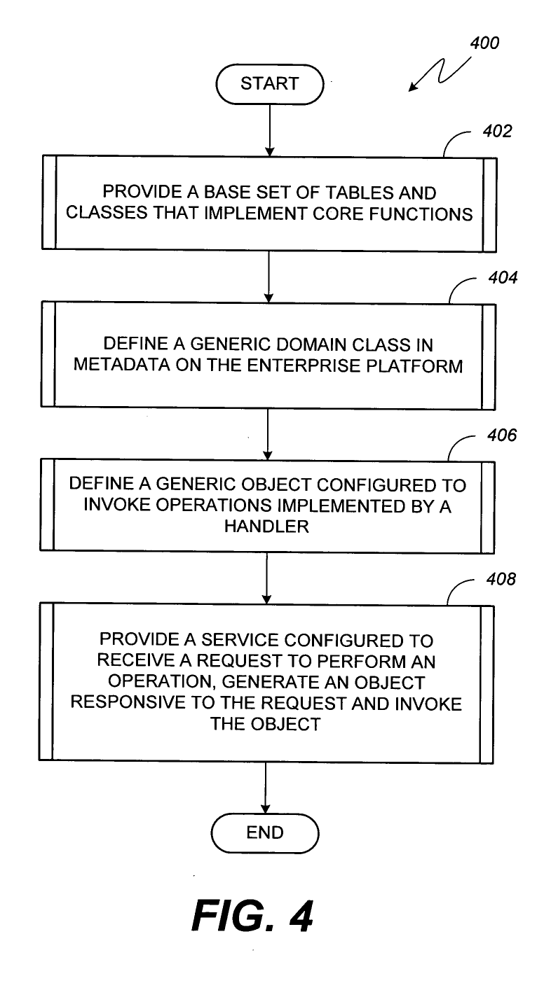

FIG. 4 is a flow diagram illustrating an embodiment of a method for extending core application behavior of an enterprise platform 110 that can be implemented by the software customization framework 300 of FIG. 3. Method 400 begins with block 402 where a base set of tables and classes are provided to implement a set of core functions such as common functionality found in an enterprise platform. In block 404, a generic domain class is defined in metadata on the enterprise platform. The generic domain class includes one or more field labels, one or more operation labels, and a dispatch scheme label. In block 406, a generic object is defined. The generic object is configured to invoke operations implemented by a handler. In block 408, a service configured to receive a request to perform an operation is provided. In turn, the service generates a custom object responsive to the generic object and the request which in turn calls an appropriate handler. The handler is configured to implement one or more defined operation(s).

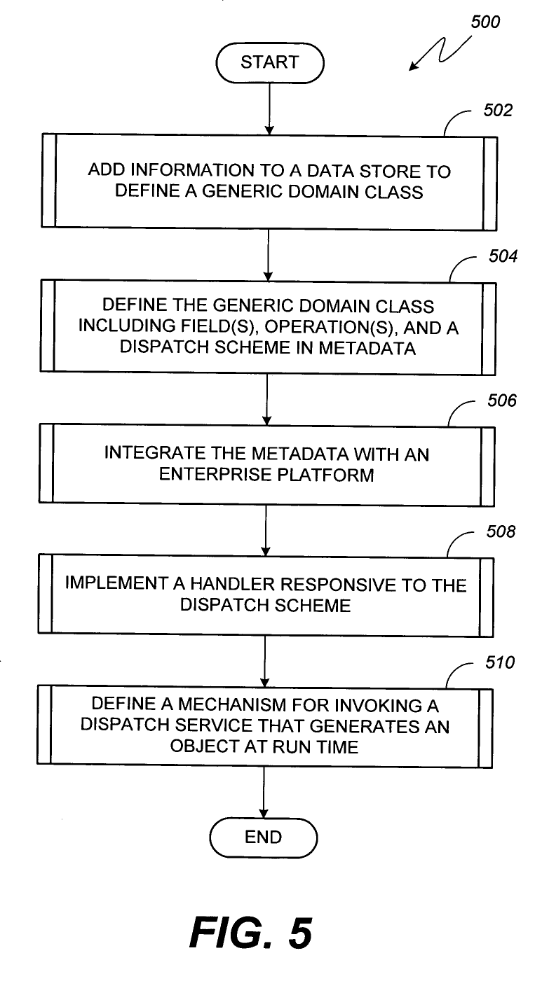

FIG. 5 is a flow diagram illustrating an embodiment of an alternative method for extending core application behavior of an enterprise platform 110 that can be implemented by the software customization framework 300 of FIG. 3. Method 500 begins with block 502 where information is added to a generic domain class in a data store. In block 504, the generic domain class including one or more fields, one or more operations, and a dispatch scheme is defined in metadata.

In the following example, metadata indicates the creation of a generic domain class called SavingsAccount.

```
<in-model name=”core”>
<class name=”SavingsAccount” package=”bank.core.account”
  style=”generic”>
<field name=”type” types=”Enumeration”>
  <attributes>
    <persistence>
    <primitive column-name=”BNK_AcctType” conversion
    strategy=”com.arch.persistence.or.conversion.StringConversion”/>
    </persistence>
  </attributes>
</field>
```

A user of the software customization framework 300 can also specify the type of dispatch scheme that will be used to invoke defined operations. For example, the following code indicates that a Java dispatch scheme, AccountJavaHandler, will be used to invoke a suspend account operation.

```
<operation name=”suspendAccount” return type=”void”>
  <attributes>
    <generic-handler
    name=”java:com.bnk.core.account.AccountJavaHandler”>
    </generic-handler>
  </attributes>
</operation>
```

In block 506, metadata is integrated with data within an enterprise platform. In block 508, a handler responsive to the dispatch scheme of block 504 is implemented. In block 510, a mechanism is defined for invoking a dispatch service that generates a custom object at run time. The custom object can be used to perform implicit and explicit data operations on data stored on various data storage devices when the data is stored in accordance with a data structure identified by the metadata framework.

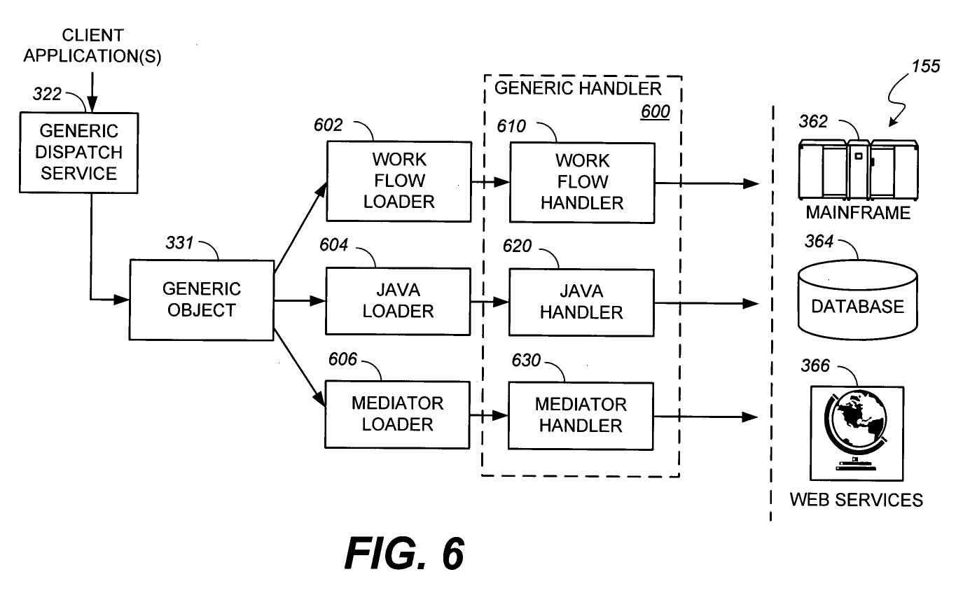

FIG. 6 is a schematic diagram illustrating the use of alternative handlers. The illustrated embodiment shows generic dispatch service 322 in communication with one or more client applications. The generic dispatch service 322 is configured to communicate with generic object 331, which wraps a value object and invokes the requested operations on the generic handler 600 that is configured for the associated domain class operation. The generic handler 600 is indirectly instructed via the generic handler attribute in the metadata and a select loader to use one of a number of specialized handlers via the generic object such as work flow handler 610, Java handler 620 and mediator handler 630. As shown in FIG. 6, a work flow loader 602 is associated with work flow handler 610; a Java loader 604 is associated with Java handler 620; and a mediator loader 606 is associated with mediator handler 630. The scheme that is specified in the generic domain class 342 (FIG. 3) determines which specialized handler will be used to implement the operation or operations defined by the object. For example, if the generic domain class 342 identifies work flow for the dispatch scheme in the metadata, the work flow loader 602 and work flow handler 610 will be used to implement any operations defined by the object. When the generic domain class 342 identifies Java as the dispatch scheme in the metadata, the Java loader 604 and Java handler 620 will be used to implement any operations defined by the object. Similarly, when the generic domain class 342 identifies mediator for the dispatch scheme in the metadata, the mediator loader 606 and mediator handler 630 will be used to implement operations defined by the object. The flow arrows exiting each of the respective handlers 610, 620, 630 illustrate that each respective handler can communicate with multiple data abstractions 360 as may be stored or otherwise available on mainframe 362, database 364 and web services 366. A software customizer will provide an implementation of a handler. The dispatch scheme identifies a handler type. The generic object will use a specialized scheme loader to load and invoke the handler for this operation. The handler is identified (but not defined) in the generic domain class' metadata for each specified operation.

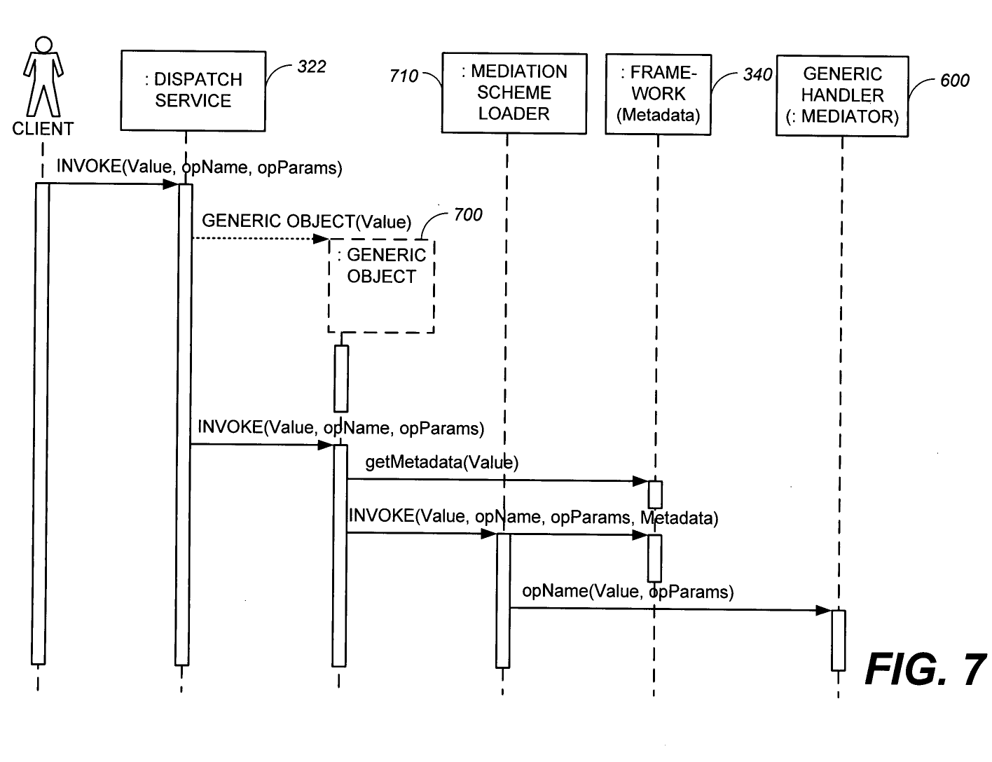

FIG. 7 is a schematic diagram illustrating information flow across the software customization framework 300 of FIG. 3. Standard data operations are invoked via a service level invoke method. As shown in the schematic, a client application issues a request in the form of an invoke function that passes a value object, the name of a desired operation and operational parameters to dispatch service 322. Dispatch service 322 generates a generic object 700 at run time. Generic object 700 is responsive to the value object that was forwarded by the client application to dispatch service 322. Dispatch service 322 directs the generic object 700 to process the operation request. Generic object 700 uses metadata to determine the identified handler for implementing the requested operation by forwarding a metadata request to framework 340 (metadata). As previously described, the getMetadata step in the information flow identifies a class descriptor, operation, and a pre-configured handler for implementing the operation. In the illustrated embodiment, a mediation scheme is identified by framework 340. In turn, generic object 700 invokes the mediation scheme loader 710 to load the mediation scheme into generic handler 600. In turn generic handler 600, using the mediation scheme, completes a desired data operation by communicating with one or more designated data abstractions.

The systems and methods for a software customization framework are defined by the appended claims. The foregoing description has been presented for purposes of illustration and description to enable one of ordinary skill to make and use the software customization framework and methods for extending enterprise applications. The foregoing description is not intended to be exhaustive or to limit the scope of the claims to the precise forms disclosed. Rather, a person skilled in the art will construe the appended claims broadly, to include other variants and embodiments of the invention, which those skilled in the art may make or use without departing from the claimed systems and methods and their equivalents.

What is claimed is:

1. A method for extending core application behavior of an enterprise platform, comprising:
providing a base set of tables and classes configured to implement a core set of functions;
defining an extension class in accordance with a generic domain class in metadata;
defining a generic domain object; and
providing a dispatch service configured to receive a request to perform an operation via the generic domain object, use the extension class and the generic domain object to emulate an executable object responsive to the request, and direct a multiple dispatch scheme directed handler defined via a generic handler attribute in the metadata to implement the operation on a data structure.

2. The method of claim 1, further comprising:
identifying a dispatch scheme in metadata.

3. The method of claim 2, wherein defining an extension class comprises identifying a field.

4. The method of claim 2, wherein defining an extension class comprises identifying an operation.

5. The method of claim 2, wherein the dispatch scheme is-selected from the group consisting of Java, work flow, and mediation.

6. The method of claim 1, wherein the generic domain object comprises a value interface between a client application and the dispatch service.

7. The method of claim 1, wherein the generic domain object comprises a second interface between the dispatch service and the multiple dispatch scheme handler.

8. The method of claim 1, wherein the dispatch service generates the generic domain object at run time.

9. A software customization framework responsive to a request that identifies a generic domain class, the software customization framework, comprising:
an enterprise platform comprising:
a metadata framework comprising a generic domain class used to configure an extension class;
a service layer configured to receive one or more inputs from a client interface, the service layer comprising a dispatch service which forwards a call to a generic executable object; and
an object layer configured to generate the generic executable object at run time, wherein the generic executable object uses the extension class to
emulate a desired object behavior and invoke a select dispatch scheme for a generic handler to apply in response to the call; and
a data structure within which the handler implements an operation responsive to the generic executable object.

10. The software customization framework of claim 9, wherein the extension class comprises representations of a field, the operation, and the select dispatch scheme.

11. The software customization framework of claim 9, wherein the select dispatch scheme is selected from the group consisting of Java, work flow, and mediation.

12. The software customization framework of claim 9, wherein a client application completes the operation on data within the data structure without having to generate additional executable code.

13. The software customization framework of claim 9, wherein the dispatch service is configured to respond to value objects and operations defined in the metadata structure.

14. The software customization framework of claim 9, wherein the generic executable object is configured to transfer data and behavior.

15. The software customization framework of claim 9, wherein the generic executable object is configured to emulate a new executable object.

16. An enterprise application extension system, comprising:
means for creating an extension class in metadata, the extension class defining a multiple-mode dispatch scheme;
means for creating a generic domain object;
means for receiving a client request to manipulate data in a data structure used to support a banking enterprise;
means for responding to the client request via an executable object generated at run time responsive to a dispatch service, the generic domain object, and the extension class, wherein said means for responding to the client request supports executable customizations without requiring new Java classes for the data structure; and
means for manipulating data in the data structure.

17. The system of claim 16, wherein the generic executable object comprises name, value, and parameter fields.

18. The system of claim 16, wherein the generic executable object comprises a first mechanism for returning a class for the object created at run time and a second mechanism for invoking an operation.

19. The system of claim 18, wherein the operation is implied.

20. The system of claim 18, wherein the operation is explicitly defined in the extension class.

21. A method for extending core application behavior of an enterprise platform without generating code when an extension class is added to metadata, comprising:
adding information to metadata defining a generic domain class;
using the generic domain class to generate an extension class including a field, an operation, and a dispatch scheme;
integrating the metadata with an enterprise platform;
generating a generic domain object;
defining a mechanism for invoking a dispatch service that generates an executable object at run time responsive to the extension class; and
directing a multiple dispatch scheme directed handler defined via a generic handler attribute in the metadata to implement the operation on data in a data structure.
